(19) United States
(12) Patent Application Publication
(10) Pub. No.: US 2024/0025789 A1
(43) Pub. Date: Jan. 25, 2024

(54) GLASS ROD MANUFACTURING DEVICE AND GLASS ROD MANUFACTURING METHOD

(71) Applicant: SUMITOMO ELECTRIC INDUSTRIES, LTD., Osaka-shi, Osaka (JP)

(72) Inventors: Tomomi MORIYA, Osaka-shi, Osaka (JP); Taishiro SATO, Osaka-shi, Osaka (JP); Kazuto MASUKO, Osaka-shi, Osaka (JP); Minoru NAKAJIMA, Osaka-shi, Osaka (JP); Yuji TSUGAWA, Osaka-shi, Osaka (JP); Takahiro SUGANUMA, Osaka-shi, Osaka (JP); Hirotaka SAKUMA, Osaka-shi, Osaka (JP); Takemi HASEGAWA, Osaka-shi, Osaka (JP)

(21) Appl. No.: 18/257,139

(22) PCT Filed: Aug. 1, 2022
(86) PCT No.: PCT/JP2022/029543

§ 371 Date: Jun. 13, 2023

(30) Foreign Application Priority Data
Aug. 30, 2021 (JP) 2021-140168

(51) Int. Cl. C03B 23/055; C03B 23/045; C03B 23/043

(52) U.S. Cl. CPC C03B 23/055; C03B 23/045; C03B 23/043

(57) ABSTRACT

A glass rod manufacturing device includes: a holding portion configured to hold one end of a starting rod; a heating portion configured to heat a bent portion; and a centering jig configured to apply a force in a first direction intersecting an axis to a part of the starting rod that whirls between the bent portion and another end of the starting rod due to rotation of the starting rod about an axis. The centering jig includes: an abutment portion configured to abut against the part; an elastic displacement portion configured to elastically displace the abutment portion in the first direction according to a run-out deviation of whirl of the part; and a slide portion configured to slide the abutment portion in a second direction intersecting the axis and the first direction according to the run-out deviation of whirl of the part.

### TECHNICAL FIELD

The present disclosure relates to a glass rod manufacturing device and a glass rod manufacturing method. The present application claims priority to Japanese Patent Application No. 2021-140168 filed on Aug. 30, 2021, the content of which is incorporated herein by reference in its entirety.

### BACKGROUND ART

A glass lathe is used to process a glass rod made of silica glass in a process for manufacturing an optical fiber (for example, Patent Literature 1). A glass lathe holds a glass rod and heats the glass rod by a heat source, such as a flame, to connect the glass rod to another glass rod, to extend the glass rod, to synthesize glass, and the like. In doing so, the heat applied to the glass rod is equalized by rotating the glass rod. Although the glass rod is typically a glass body having a substantially cylindrical external shape, the cross-sectional shape is not limited to a circle, and glass bodies having a polygonal, elliptic, star-shaped, or D-shaped cross-sectional shape may be included as well as those in which the outer diameter or shape changes in the longitudinal direction. Additionally, those having one or a plurality of openings in the cross-section, such as a tube, may also be included. Additionally, those in which a plurality of glass rods are connected in the longitudinal direction may also be included.

### CITATION LIST

### Patent Literature

Patent Literature 1: Japanese Unexamined Patent Publication No. 2004-50303

### SUMMARY OF INVENTION

A glass rod manufacturing device of the present disclosure is a glass rod manufacturing device for manufacturing a glass rod centered from a starting rod having at least one bent portion, the glass rod manufacturing device including: a holding portion configured to hold one end of the starting rod; a heating portion configured to heat a bent portion of the at least one bent portion; and a centering jig configured to apply a force in a first direction intersecting an axis to a part of the starting rod that whirls between the bent portion and another end of the starting rod due to rotation of the starting rod about the axis, wherein the centering jig includes: an abutment portion configured to abut against the part; an elastic displacement portion configured to elastically displace the abutment portion in the first direction according to a run-out deviation of whirl of the part; and a slide portion configured to slide the abutment portion in a second direction intersecting the axis and the first direction according to the run-out deviation of whirl of the part.

A glass rod manufacturing method of the present disclosure is a glass rod manufacturing method for manufacturing a glass rod centered from a starting rod having at least one bent portion, the glass rod manufacturing method including: holding one end of the starting rod; heating a bent portion of the at least one bent portion; and centering the starting rod by applying a force in a first direction intersecting an axis to a part of the starting rod that whirls between the bent portion and another end of the starting rod due to rotation of the starting rod about the axis, wherein in the centering, an abutment portion configured to abut against the part is elastically displaced in the first direction according to a run-out deviation of whirl of the part; and slid in a second direction intersecting the axis and the first direction according to the run-out deviation of whirl of the part.

### BRIEF DESCRIPTION OF DRAWINGS

FIG. 1 is a side view describing a glass rod manufacturing device according to an embodiment and a glass rod to be processed.

FIG. 2 is a front view describing the glass rod manufacturing device according to an embodiment and the glass rod to be processed.

FIG. 3 is a diagram for describing the whirl of a starting rod.

FIG. 4 is a flow chart illustrating a glass rod manufacturing method according to an embodiment.

FIG. 5 is a side view of a glass rod manufacturing device according to a variation.

### DESCRIPTION OF EMBODIMENTS

### Problems to be Solved by Invention

When there is a bend (bent portion) in the glass rod in the manufacturing process described above, the glass rod may whirl about the axis of rotation when rotated. Consequently, centering of the glass rod is performed. Centering is a process of reducing the bend in the glass rod to reduce the whirl of the glass rod in the entire length or in at least a portion of the length of the glass rod.

It is an object of the present disclosure to provide a glass rod manufacturing device and a glass rod manufacturing method in which centering is facilitated.

### Advantageous Effects of Present Disclosure

The present disclosure is capable of providing a glass rod manufacturing device and a glass rod manufacturing method in which centering is facilitated.

### Description of Embodiments of Present Disclosure

Embodiments of the present disclosure will first be listed and described. A glass rod manufacturing device according to an embodiment of the present disclosure is a glass rod manufacturing device for manufacturing a glass rod centered from a starting rod having at least one bent portion, the glass rod manufacturing device including: a holding portion configured to hold one end of the starting rod; a heating portion configured to heat a bent portion of the at least one bent portion; and a centering jig configured to apply a force in a first direction intersecting an axis to a part of the starting rod that whirls between the bent portion and another end of the starting rod due to rotation of the starting rod about the axis, wherein the centering jig includes: an abutment portion configured to abut against the part; an elastic displacement portion configured to elastically displace the abutment portion in the first direction according to a run-out deviation of whirl of the part; and a slide portion configured to slide the abutment portion in a second direction intersecting the axis and the first direction according to the run-out deviation of whirl of the part.

In the glass rod manufacturing device above, the abutment portion configured to abut against the part that whirls due to the rotation of the starting rod is elastically displaced in the first direction by the elastic displacement portion and slid in the second direction by the slide portion according to the run-out deviation of whirl of the part. Thus, the abutment portion can continue to apply a force in the first direction automatically to the part of the starting rod against which the abutment portion abuts. Consequently, centering can be facilitated.

The abutment portion may include a pair of abutment members disposed along the second direction. In this case, the starting rod can be supported at two points by the pair of abutment members.

Each of the pair of abutment members may be a roller having a central axis along the axis and rotatable about the central axis. In this case, the pair of abutment members rotate in conjunction with the rotation of the starting rod, so that inhibition of the rotation of the starting rod is suppressed.

The pair of abutment members may face each other in the second direction at a distance smaller than a diameter of the starting rod. In this case, the starting rod can be reliably supported at two points by the pair of abutment members.

The abutment portion may have a V-groove. In this case, the starting rod can be supported at two points by a pair of surfaces of the V-groove.

The abutment portion may include a heat resistant resin. In this case, the abutment portion has heat resistance and can be abutted against the heated starting rod. In addition, damage to the starting rod is suppressed since the abutment portion is made of resin.

The centering jig may further include a position adjustment portion configured to adjust the position of the abutment portion in the first direction. In this case, the abutment portion can be reliably abutted against the starting rod.

The abutment portion may be fixed to the slide portion, and the elastic displacement portion may elastically displace the slide portion together with the abutment portion in the first direction. In this case, a configuration in which the abutment portion is elastically displaced in the first direction and slid in the second direction can be easily achieved.

A glass rod manufacturing method according to an embodiment of the present disclosure is a glass rod manufacturing method for manufacturing a glass rod centered from a starting rod having at least one bent portion, the glass rod manufacturing method including holding one end of the starting rod; heating a bent portion of the at least one bent portion; and centering the starting rod by applying a force in a first direction intersecting an axis to a part of the starting rod that whirls between the bent portion and another end of the starting rod due to rotation of the starting rod about the axis, wherein in the centering, an abutment portion configured to abut against the part is elastically displaced in the first direction according to a run-out deviation of whirl of the part; and slid in a second direction intersecting the axis and the first direction according to the run-out deviation of whirl of the part.

In the glass rod manufacturing method above, the abutment portion that abuts against the part that whirls due to the rotation of the starting rod is elastically displaced in the first direction by the elastic displacement portion and slid in the second direction by the slide portion according to the run-out deviation of whirl of the part. Thus, the abutment portion can continue to apply a force in the first direction automatically to the part of the starting rod against which the abutment portion abuts. Consequently, centering can be facilitated.

The centering may be performed on the at least one bent portion in order from the bent portion closest to the one end from among the at least one bent portion. In this case, the centering of the glass rod can be performed effectively.

### Details of Embodiments of Present Disclosure

Specific examples of a glass rod manufacturing device of the present disclosure will be described below with reference to the drawings. The present invention is not limited to these examples, but is defined by the scope of the claims and is intended to include all modifications within the meaning and scope equivalent to the scope of the claims. Same reference signs are given to the same elements in the description of the drawings, and redundant description will be omitted.

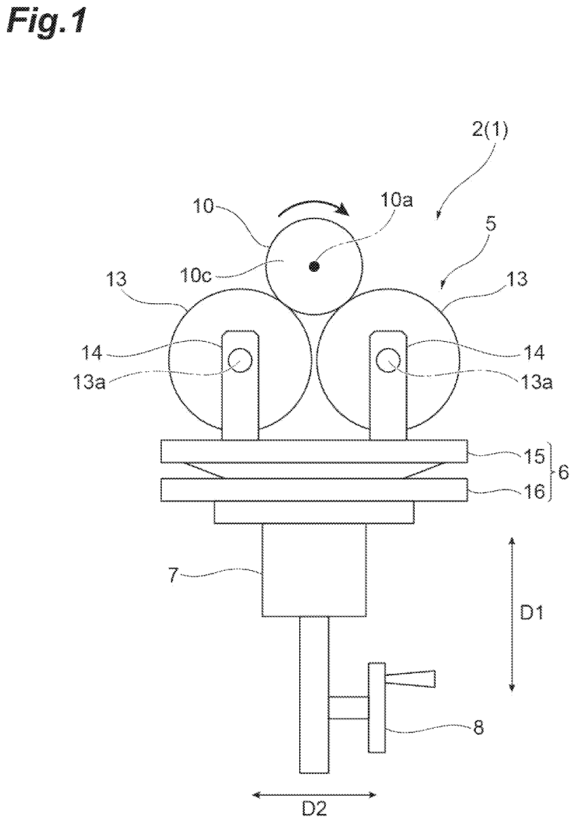

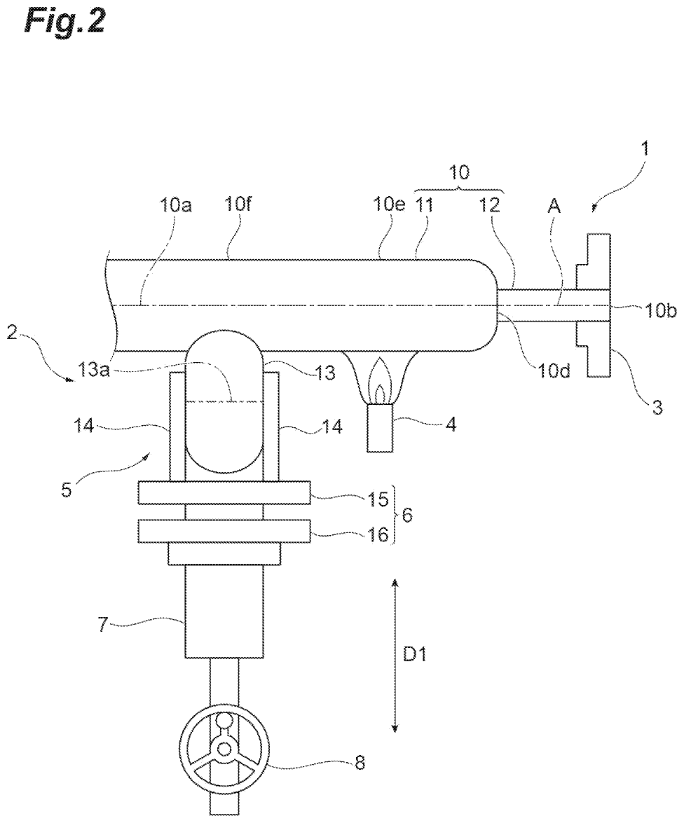

FIG. 1 is a side view describing a glass rod manufacturing device according to an embodiment and a glass rod to be processed. FIG. 2 is a front view describing the glass rod manufacturing device according to an embodiment and the glass rod to be processed. A glass rod manufacturing device 1 illustrated in FIGS. 1 and 2 is a glass lathe for manufacturing a glass rod centered from a starting rod 10, which is a glass rod having at least one bent portion.

The starting rod 10 and the centered glass rod are rod-like bodies, and include, for example, silica glass. The starting rod 10 and the glass rod may be solid or hollow. The starting rod 10 may have one or a plurality of openings (through holes) that extend along a central axis 10a of the starting rod 10. Similarly, the glass rod may have one or a plurality of openings (through holes) that extend along a central axis of the glass rod. The starting rod 10 has one end 10b and the other end 10c in a longitudinal direction.

In this embodiment, the starting rod 10 has a body 11 and a dummy rod 12. The body 11 is a part to be the glass rod of which the shape is to be changed or on which glass is to be deposited by causing a heating portion of the manufacturing device to act thereon, and has at least one bent portion. The body 11 is, for example, a long glass rod formed by connecting a plurality of glass rods. The bent portion of the body 11 is, for example, formed of a connection portion of glass rods. The dummy rod 12 is a rod primarily used to adjust the position of the body 11 relative to the heating portion of the manufacturing device. The dummy rod 12 is, for example, a glass rod that is made of the same material as the body 11, has a diameter smaller than that of the starting rod 10, and is shorter than the starting rod 10. In this embodiment, the dummy rod 12 does not have a bent portion.

The body 11 and the dummy rod 12 are connected to each other at ends thereof. The dummy rod 12 is attached to the body 11, for example, by welding. The dummy rod 12 includes the one end 10b. The body 11 includes the other end 10c. The starting rod 10 may be constituted of only the body 11 without having the dummy rod 12. In this case, the body 11 would include the one end 10b and the other end 10c with the bent portion therebetween.

For example, in a case in which a central axis of the dummy rod 12 is inclined relative to a central axis of the body 11 due to an attachment error of the dummy rod 12, a connection portion 10d between the body 11 and the dummy rod 12 forms a bent portion of the starting rod 10. As described above, the body 11 has at least one bent portion other than the connection portion 10d. Thus, in the case in which the connection portion 10d is a bent portion, the starting rod 10 has at least two bent portions.

The glass rod manufacturing device 1 includes a centering jig 2, a holding portion 3, and a heating portion 4. The holding portion 3 is configured to be able to hold (or support) the one end 10b of the starting rod 10. The holding portion 3 is, for example, a chuck that holds the one end 10b. The holding portion 3 cantilevers the starting rod 10. The one end 10b is fixed by the holding portion 3, and is thus a fixed end. The other end 10c (distal end) is a free end. The holding portion 3 is rotated about a predetermined axis A by a drive mechanism not shown with the holding portion 3 holding the starting rod 10. The axis A is an axis of rotation of the holding portion 3. The holding portion 3 holds the one end 10b such that the central axis 10a is coincident with the axis A at at least the one end 10b. In this embodiment, the holding portion 3 holds the one end 10b such that at least the central axis of the dummy rod 12 is coincident with the axis A.

Although in FIG. 2, the central axis 10a of the starting rod 10 is illustrated as being coincident with the axis A, since the starting rod 10 has a bent portion, the central axis 10a actually has a part that is not coincident with the axis A on a side of the bent portion closer to the other end 10c. For example, in the case in which the connection portion 10d is a bent portion (the case in which the central axis of the dummy rod 12 is inclined relative to the central axis of the body 11), the central axis 10a would not be coincident with the axis A from the connection portion 10d to the other end 10c. When the starting rod 10 rotates about the axis A due to the rotation of the holding portion 3, the part of the starting rod 10 at which the central axis 10a is not coincident with the axis A whirls about the axis A.

The heating portion 4 is configured to be able to heat a bent portion 10e to be centered from among the at least one bent portion of the starting rod 10. The heating portion 4 is, for example, a burner that burns hydrogen gas. The heating portion 4 is, for example, provided movable along the axis A, and capable of heating a predetermined location in the longitudinal direction of the starting rod 10. The bent portion 10e is illustrated as being straight in FIG. 2, since it is only slightly bent.

The centering jig 2 is configured to apply a force in a first direction D1 intersecting the axis A to a predetermined part 10f that whirls between the bent portion 10e and the other end 10c due to the rotation of the starting rod 10 about the axis A. That is, the centering jig 2 is configured to apply a force in the first direction D1 to the predetermined part 10f of the starting rod 10 in which the bent portion 10e to be centered is heated with the one end 10b being held and the starting rod 10 being rotated about the axis A, the predetermined part 10f being a part that is positioned closer to the other end 10c than the bent portion 10e and whirls due to the rotation. The predetermined part 10f is, for example, a bent portion that is positioned closer to the other end 10c than the bent portion 10e, or the other end 10c. In this embodiment, the first direction D1 is a direction of gravity and is perpendicular to the axis A. The first direction D1 is not necessarily limited to the direction of gravity, and may, for example, be a horizontal direction. The centering jig 2 has an abutment portion 5, a slide portion 6, an elastic displacement portion 7, and a position adjustment portion 8.

The abutment portion 5 has a pair of abutment members 13 that abut against the predetermined part 10f of the starting rod 10 that whirls due to rotation. The pair of abutment members 13 are disposed along a second direction D2 intersecting the axis A and the first direction D1. In this embodiment, the second direction D2 is perpendicular to the axis A and the first direction D1. The pair of abutment members 13 face each other in the second direction D2 at a distance smaller than a diameter of the starting rod 10.

Each of the pair of abutment members 13 is a roller that has a central axis 13a along the axis A and that is rotatable about the central axis 13a. The pair of abutment members 13 rotate according to the rotation of the starting rod 10. The abutment members 13 are circular when seen from a direction along the central axis 13a. The abutment members 13 are, for example, disc members or spherical members. An abutment surface of the abutment members 13 have a shape in which the middle bulges outward. More specifically, the abutment surface has a curved surface shape such that the surface is farther away from the central axis 13a closer to the middle in a direction along the central axis 13a. The abutment surface may have a chamfered shape in which both ends in the direction along the central axis 13a are rounded. Such abutment surface without any corners are capable of supporting the starting rod 10 without damaging the starting rod 10.

The abutment portion 5 includes a heat resistant resin. The heat resistant temperature of the abutment portion 5 is, for example, preferably 100° C. or higher, and is more preferably 200° C. or higher. An example of the heat resistant resin includes fluororesin such as Teflon (registered trademark). In this embodiment, the abutment members 13 are Teflon rollers. Such resin material is not harder than glass, the unevenness of the surface can be reduced, and this facilitates sliding. The starting rod 10 can thus be supported without being damaged.

The abutment portion 5 has a support member 14 that pivotally supports the pair of abutment members 13. In this embodiment, a pair of the support members 14 is provided for each abutment member 13. That is, the abutment portion 5 has four support members 14. The pair of support members 14 are disposed on either side of the abutment member 13 in the direction along the central axis 13a. The support members 14 are fixed to a first slide member 15 described below of the slide portion 6. The abutment portion 5 is thus fixed to the slide portion 6.

The slide portion 6 is configured to slide the abutment portion 5 in the second direction D2 according to a run-out deviation of whirl of the predetermined part 10f of the starting rod 10. The slide portion 6 has the first slide member 15 to which the abutment portion 5 is fixed, and a second slide member 16 that supports the first slide member 15 so that the first slide member 15 is capable of sliding in the second direction D2. The first slide member 15 slides and moves, together with the abutment portion 5, in the second direction D2 relative to the second slide member 16, and absorbs the runout in the second direction D2 of the starting rod 10 relative to the abutment portion 5.

The first slide member 15 and the second slide member 16 are, for example, plate-like members disposed facing each other in the first direction D1. As one example, the second slide member 16 has a rail extending along the second direction D2, and the first slide member 15 has an engaging portion that engages the rail. A slide mechanism of the slide portion 6 is achieved by the engaging portion of the first slide member 15 engaging the rail of the second slide member 16. The slide mechanism may also be achieved by other publicly known means.

The elastic displacement portion 7 is configured to elastically displace the abutment portion 5 in the first direction D1 according to the run-out deviation of whirl of the predetermined part 10f of the starting rod 10. The elastic displacement portion 7 is fixed to the slide portion 6, and elastically displaces the slide portion 6 together with the abutment portion 5 in the first direction D1. The elastic displacement portion 7 is attached to the second slide member 16 on a side opposite the first slide member 15. The elastic displacement portion 7 is, for example, a coil spring or an air spring, and absorbs the runout of the starting rod 10 in the first direction D1 relative to the abutment portion 5.

The position adjustment portion 8 is configured to be able to adjust the position of the abutment portion 5 in the first direction D1. The position adjustment portion 8 includes, for example, a cylinder extendable in the first direction D1. The position adjustment portion 8 is provided on the elastic displacement portion 7 on a side opposite the slide portion 6, and supports the abutment portion 5 via the elastic displacement portion 7 and the slide portion 6. The position adjustment portion 8, for example, adjusts the position of the abutment portion 5 in the first direction D1 by manipulation of a handle.

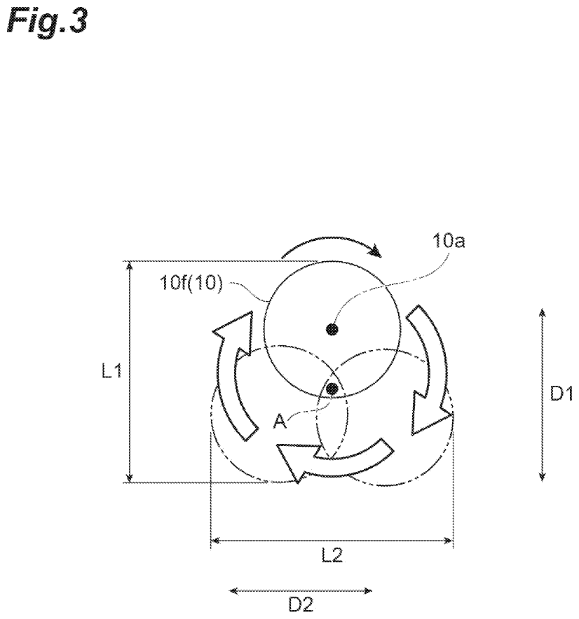

FIG. 3 is a diagram for describing the whirl of a starting rod. FIG. 3 illustrates the whirl of the predetermined part 10f of the starting rod 10. The predetermined part 10f whirls, for example, with the axis A as an axis of rotation. As one example, a run-out deviation L1 of the starting rod 10 in the first direction D1 is equal to a run-out deviation L2 of the starting rod 10 in the second direction D2, but the run-out deviation L1 and the run-out deviation L2 may be different from each other. The elastic displacement portion 7 is configured to be able to absorb, in the first direction D1, at least the runout of the run-out deviation L1. That is, the elastic displacement portion 7 is configured such that the range of motion of the abutment portion 5 in the first direction D1 is equal to or more than the run-out deviation L1. The slide portion 6 is configured to be able to absorb, in the second direction D2, at least the runout of the run-out deviation L2. That is, the slide portion 6 is configured such that the range of motion of the abutment portion 5 in the second direction D2 is equal to or more than the run-out deviation L2.

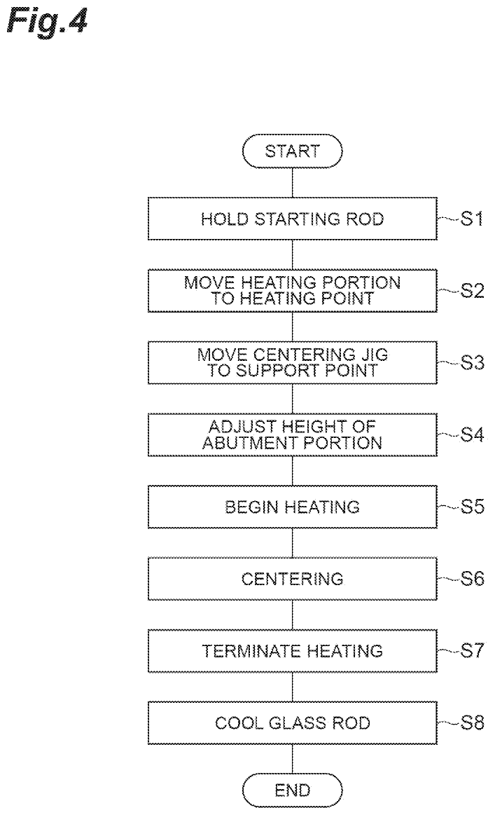

FIG. 4 is a flow chart illustrating a glass rod manufacturing method according to an embodiment. The glass rod manufacturing method according to the embodiment is a method for manufacturing a glass rod centered from the starting rod 10 having at least one bent portion. The glass rod manufacturing method is performed using the glass rod manufacturing device 1. The glass rod manufacturing method includes steps S1 to S8 as illustrated in FIG. 4.

Step S1 is a step of holding the one end 10b of the starting rod 10 by the holding portion 3. The starting rod 10 is held by the holding portion 3 such that the central axis 10a is coincident with the axis A at at least the one end 10b. In this embodiment, the starting rod 10 is attached to the holding portion 3 such that at least the central axis of the dummy rod 12 is coincident with the axis A.

Step S2 is a step of moving the heating portion 4 to the bent portion 10e to be centered (heating point). Here, the bent portion closest to the one end 10b is set as the bent portion 10e to be centered. The bent portion closest to the one end 10b can be easily specified as the part that exhibits the minimum whirl when the starting rod 10 is rotated by the holding portion 3. This step may be performed while rotating the starting rod 10.

Step S3 is a step of moving the centering jig 2 to the predetermined part 10f (support point). The predetermined part 10f is a part that is positioned closer to the other end 10c than the bent portion 10e to be centered and whirls due to rotation. Here, the part closest to the bent portion 10e to be centered is set as the predetermined part 10f from among the bent portions and the other end 10c. The predetermined part 10f can be easily specified as the part that exhibits the maximum whirl when the starting rod 10 is rotated by the holding portion 3 This step may be performed, for example, while rotating the starting rod 10.

Step S4 is a step of adjusting a height (position in the first direction D1) of the abutment portion 5 by the position adjustment portion 8. The height of the abutment portion 5 is adjusted to a height at which the abutment portion 5 abuts against the starting rod 10 even in a case in which the starting rod 10 whirls the farthest away from the centering jig.

Step S5 is a step of beginning heating of the bent portion 10e to be centered by the heating portion 4. This step is performed by igniting the burner in the case in which the heating portion 4 is a burner.

Step S6 is a step of centering the bent portion 10e to be centered by the centering jig 2. This step is performed with the one end 10b of the starting rod 10 being held by the holding portion 3, and the starting rod 10 being rotated about the axis A. This step is also performed while heating the bent portion 10e by the heating portion 4. In this step, a force in the first direction D1 is applied to the predetermined part 10f that whirls between the bent portion 10e and the other end 10c due to the rotation of the starting rod 10 about the axis A. That is, a force in the first direction D1 is applied, by the abutment portion 5, to the predetermined part 10f which is the part closer to the other end 10c than the bent portion 10e and whirls due to rotation.

In this step, the abutment portion 5 is abutted against the predetermined part 10f by being displaced by the elastic displacement portion 7 in the first direction D1 according to the run-out deviation of whirl of the predetermined part 10f, and by being slid by the slide portion 6 in the second direction D2 according to the run-out deviation of whirl of the predetermined part 10f. The bent portion 10e can be corrected and centered by softening the bent portion 10e to be centered and continuing to apply, from the side, a force in the first direction D1 to the predetermined part 10f closer to the other end 10c than the bent portion 10e. Correcting the bent portion 10e refers to reducing the bend in the bent portion 10e.

Step S7 is a step of terminating heating by the heating portion 4. This step is performed by turning off the burner in the case in which the heating portion 4 is a burner.

Step S8 is a step of cooling the starting rod 10. This step is performed, for example, while rotating the starting rod 10.

Steps S2 to S8 are repeated as necessary. Steps S2 to S8 are repeated until all the bent portions of the starting rod 10 are corrected. The bent portions of the starting rod 10 are to be centered and corrected in order from the one end 10b side. That is, steps S2 to S8 are performed on all of the at least one bent portion in order from the bent portion closest to the one end 10b from among the at least one bent portion.

As described above, in the glass rod manufacturing device 1 and the glass rod manufacturing method according to this embodiment, the abutment portion 5 is elastically displaced by the elastic displacement portion 7 in the first direction D1, and slid by the slide portion 6 in the second direction D2, according to the run-out deviation of whirl of the predetermined part 10f. Thus, the abutment portion 5 can continue to apply a force in the first direction D1 automatically to the predetermined part 10f. Centering of the bent portion can thus be performed automatically, so that centering is facilitated. The glass rod manufacturing device 1 and the glass rod manufacturing method according to this embodiment are effective, particularly when manufacturing a long glass rod, since the number of centerings and the operation time will increase.

The abutment portion 5 includes the pair of abutment members 13 disposed along the second direction D2. The starting rod 10 can thus be supported at two points by the pair of abutment members 13.

Each of the pair of abutment members 13 is a roller that has the central axis 13a along the axis A and that is rotatable about the central axis 13a. The pair of abutment members 13 rotate in conjunction with the rotation of the starting rod 10, so that inhibition of the rotation of the starting rod 10 is suppressed.

The pair of abutment members 13 face each other in the second direction D2 at a distance smaller than the diameter of the starting rod 10. The starting rod 10 can thus be reliably supported at two points by the pair of abutment members 13.

The abutment portion 5 includes a heat resistant resin. The abutment portion 5 has heat resistance and can be abutted against the heated starting rod 10. In addition, damage to the starting rod 10 is suppressed since the abutment portion 5 is made of a resin material.

The centering jig 2 includes the position adjustment portion 8 that adjusts the position of the abutment portion 5 in the first direction D1, and thus enables the abutment portion 5 to be reliably abutted against the starting rod 10.

The abutment portion 5 is fixed to the slide portion 6, and the elastic displacement portion 7 elastically displaces the slide portion 6 together with the abutment portion 5 in the first direction D1. Thus, a configuration in which the abutment portion 5 is elastically displaced in the first direction D1 and slid in the second direction D2 can be easily achieved.

In the glass rod manufacturing method according to this embodiment, steps S2 to S8 are performed on at least one bent portion in order from the bent portion closest to the one end 10b from among the at least one bent portion. Centering of the glass rod can thus be performed effectively.

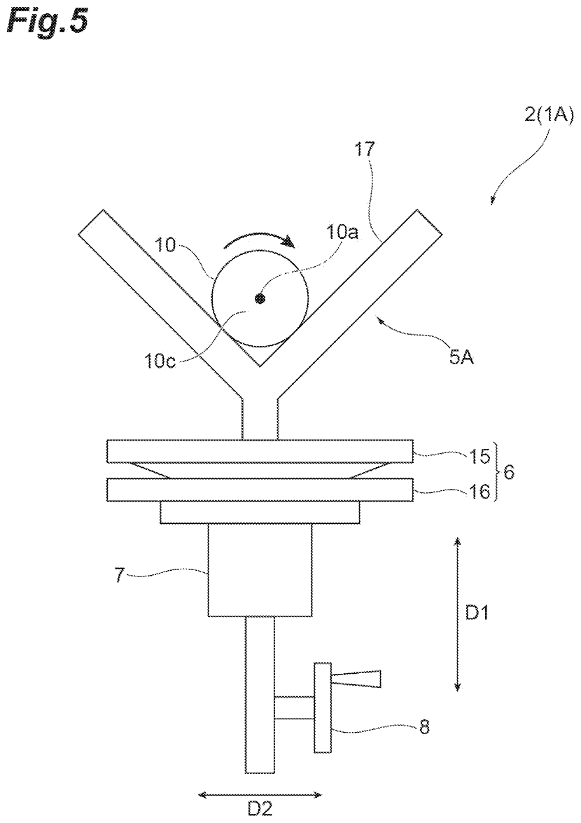

FIG. 5 is a side view of a glass rod manufacturing device according to a variation. As illustrated in FIG. 5, a glass rod manufacturing device 1A according to the variation is different from the glass rod manufacturing device 1 (see FIG. 1) in that the centering jig 2 has an abutment portion 5A. The abutment portion 5A has a V-groove 17, and a pair of surfaces of the V-groove 17 abut against the predetermined part 10f. The V-groove 17 is fixed to the first slide member 15 of the slide portion 6. The V-groove 17 is formed, for example, of a heat resistant resin. The abutment portion 5A has the V-groove 17 in the glass rod manufacturing device 1A, so that the starting rod 10 can be supported at two points by the pair of surfaces of the V-groove 17.

The present disclosure is not limited to the embodiments and variation above. The embodiments and variation above may be combined as appropriate.

### REFERENCE SIGNS LIST

1, 1A Glass rod manufacturing device
2 Centering jig
3 Holding portion
4 Heating portion
5, 5A Abutment portion
6 Slide portion
7 Elastic displacement portion
8 Position adjustment portion
10 Starting rod
10a Central axis
10b One end
10c Other end
10d Connection portion
10e Bent portion
10f Predetermined part
11 Body
12 Dummy rod
13 Abutment member
13a Central axis
14 Support member
15 First slide member
16 Second slide member
17 V-groove
A Axis
D1 First direction
D2 Second direction
L1 Run-out deviation
L2 Run-out deviation

What is claimed is:

1. A glass rod manufacturing device for manufacturing a glass rod centered from a starting rod having at least one bent portion, the glass rod manufacturing device comprising:
a holding portion configured to hold one end of the starting rod;
a heating portion configured to heat a bent portion of the at least one bent portion; and
a centering jig configured to apply a force in a first direction intersecting an axis to a part of the starting rod that whirls between the bent portion and another end of the starting rod due to rotation of the starting rod about the axis,
wherein the centering jig includes:
an abutment portion configured to abut against the part;
an elastic displacement portion configured to elastically displace the abutment portion in the first direction according to a run-out deviation of whirl of the part; and
a slide portion configured to slide the abutment portion in a second direction intersecting the axis and the first direction according to the run-out deviation of whirl of the part.

2. The glass rod manufacturing device according to claim 1, wherein the abutment portion includes a pair of abutment members disposed along the second direction.

3. The glass rod manufacturing device according to claim 2, wherein each of the pair of abutment members is a roller having a central axis along the axis and rotatable about the central axis.

4. The glass rod manufacturing device according to claim 2, wherein the pair of abutment members face each other in the second direction at a distance smaller than a diameter of the starting rod.

5. The glass rod manufacturing device according to claim 1, wherein the abutment portion has a V-groove.

6. The glass rod manufacturing device according to claim 1, wherein the abutment portion includes a heat resistant resin.

7. The glass rod manufacturing device according to claim 1, wherein the centering jig further includes a position adjustment portion configured to adjust a position of the abutment portion in the first direction.

8. The glass rod manufacturing device according to claim 1,
wherein the abutment portion is fixed to the slide portion, and
wherein the elastic displacement portion is configured to elastically displace the slide portion together with the abutment portion in the first direction.

9. A glass rod manufacturing method for manufacturing a glass rod centered from a starting rod having at least one bent portion, the glass rod manufacturing method comprising:
holding one end of the starting rod;
heating a bent portion of the at least one bent portion; and
centering the starting rod by applying a force in a first direction intersecting an axis to a part of the starting rod that whirls between the bent portion and another end of the starting rod due to rotation of the starting rod about the axis,
wherein in the centering, an abutment portion configured to abut against the part is elastically displaced in the first direction according to a run-out deviation of whirl of the part, and slid in a second direction intersecting the axis and the first direction according to the run-out deviation of whirl of the part.

10. The glass rod manufacturing method according to claim 9, wherein the centering is performed on the at least one bent portion in order from the bent portion closest to the one end from among the at least one bent portion.
